(19) United States
(12) Patent Application Publication
(10) Pub. No.: US 2013/0241762 A1
(43) Pub. Date: Sep. 19, 2013

(54) LIGHT-BEAM SCANNING FOR LASER RADAR AND OTHER USES

(71) Applicant: NIKON CORPORATION, Chiyoda-ku (JP)

(72) Inventors: Daniel G. Smith, Tucson, AZ (US); Alexander Cooper, Belmont, CA (US); Eric Peter Goodwin, Tucson, AZ (US); Yuichi Takigawa, Kawasaki (JP); Alec Robertson, Palo Alto, CA (US)

(73) Assignee: Nikon Corporation, Chiyoda-ku (JP)

(21) Appl. No.: 13/840,686

(22) Filed: Mar. 15, 2013

Related U.S. Application Data
(60) Provisional application No. 61/612,027, filed on Mar. 16, 2012.
(60) Provisional application No. 61/659,798, filed on Jun. 14, 2012.

(51) Int. Cl. G02B 26/10; G01S 13/86; G01B 11/24; G01C 3/08

(52) U.S. Cl. CPC G02B 26/10; G01C 3/08; G01S 13/865; G02B 26/103; G01B 11/24
USPC 342/54; 356/4.01; 356/139.04; 359/197.1; 359/205.1; 359/209.1; 359/201.1; 356/601; 359/212.1; 359/201.2; 356/445

(57) ABSTRACT

A light beam is scanned, for use in laser radar and other uses, by an optical system of which an example includes a beam-shaping optical system that includes a first movable optical element and a second movable optical element. The first optical element forms and directs an optical beam along a nominal propagation axis from the beam-shaping optical system to a target, and the second optical element includes a respective actuator by which the second optical element is movable relative to the first optical element. A controller is coupled at least to the actuator of the second optical element and is configured to induce motion, by the actuator, of the second optical element to move the optical beam, as incident on the target, relative to the nominal propagation axis.

### CROSS-REFERENCE TO RELATED APPLICATIONS

This application claims priority to and the benefit of U.S. Provisional Application No. 61/612,027, filed on Mar. 16, 2012, and U.S. Provisional Application No. 61/659,798, filed on Jun. 14, 2012, both of which are incorporated herein by reference in their respective entireties. This application is also related to U.S. patent application Ser. No. 13/840,093, entitled “Beam Steering for Laser Radar and Other Uses,” filed concurrently with the present application and incorporated herein by reference.

### FIELD

The disclosure pertains to, inter alia, imparting a scanning or sweeping motion to a beam of light, particularly to a substantially collimated beam such as a laser beam. The devices and methods disclosed herein can be used, for example, to impart a scanning or sweeping motion to an interrogation beam produced by a laser radar system.

### BACKGROUND

Various applications have been developed for using substantially collimated beams of light that are directed onto the surface of a object. One application, called laser radar, involves directing a laser beam to an object or site called a “target” herein. Laser radar (also called “LIDAR” or “LADAR”) is a remote-sensing technique used for measuring distance to and/or surface properties of a target by illuminating the target surface with light pulses produced by a laser. Laser radar systems are particularly useful for inspection applications in which large objects or complex surfaces are to be measured such as in the manufacture and assessment of aircraft, automobile, wind turbine, satellite, marine, and other oversized parts. Some conventional laser radar systems are described in the following U.S. Pat. Nos. 4,733,609; 4,824,251; 4,830,486; 4,969,736; 5,114,226; 7,139,446; and 7,925,134; and in Japan Patent No. 2,664,399, all of which are incorporated herein by reference to the fullest extent allowed by law. In these conventional laser radar systems, a laser beam (called an “interrogation beam”) is directed to and scanned over a region of the target surface. Portions of the interrogation beam that are reflected or scattered back from the target to the laser radar system are detected, and the resulting signals are processed to produce usable information about the target.

Referring to FIG. 11, a conventional laser radar system 250 typically comprises the following subsystems: (a) a source 252 of a laser beam 253 or other substantially collimated light beam, (b) a beam-shaping optical system 254 that receives the beam 253 from the source and directs, shapes, and focuses the beam into an interrogation beam 255, (c) a sending optical system 256 that directs the interrogation beam 255 to a target 258, (d) a scanning device 260 that imparts motion to the beam-shaping optical system 254 and sending optical system 256 so as to scan the interrogation beam over a selected region on the target surface (beam scanning is usually one or both of azimuth and elevation), (e) a receiving optical system 262 that receives light 257 (from the interrogation beam 255) reflected from the target back to the system 250 (the receiving optical system 262 includes a photodetector, not detailed, that produces an electronic signal corresponding to the received light 257), and (f) a signal-processing system that converts the signal from the photodetector into usable data concerning the scanned region of the target. The beam-shaping optical system 254 and sending optical system 256 collectively have large mass, which limits the rate at which the scanning device 260 can move them, particularly if the motion is a periodic motion. I.e., the maximum achievable beam-scanning rate is adversely affected by the mass that must be moved by the scanning device 260. The resulting compromised scanning rate can limit the rate at which the system 250 produces information about the target.

Therefore, there is a need for beam-scanning systems of which the mass that is actually moved to achieve scanning of the beam is substantially less than in conventional systems, and hence are less limited in the rates at which the beam can be moved in a scanning manner.

### SUMMARY

A first aspect of this disclosure pertains to optical systems that impart a scanning motion to a light beam. An exemplary embodiment of such a system comprises a beam-shaping optical system including a first movable optical element and a second movable optical element. The first optical element forms and directs an optical beam along a nominal propagation axis from the beam-shaping optical system to a target. The second optical element includes a respective actuator by which the second optical element is movable relative to the first optical element. A controller is coupled at least to the actuator of the second optical element and is configured to induce the actuator to move the second optical element. This motion of the second optical element moves the optical beam, as incident on the target, relative to the nominal propagation axis. This particular configuration allows the second optical element to be moved by itself, as induced by its actuator, to produce, for example, a fine scanning motion of the light beam relative to the nominal propagation axis. Meanwhile, the first optical element can be moved by a separate actuator to change the focus of the optical beam.

The optical system may also be coupled to one or more additional actuators that are energized as required to set the nominal propagation axis with desired elevation and/or azimuth. The additional actuator(s) can be operated to provide time-variant elevation and/or azimuth, thereby producing, for example, a large-scale scanning motion of the nominal propagation axis (and thus of the optical beam). Meanwhile, the second optical element can be moved by its actuator to produce a fine-scan motion of the optical beam relative to the nominal propagation axis. Further meanwhile, the first optical element can be moved by its actuator as required for beam shaping during all these scanning motions of the optical beam. These motions desirably are controlled by a controller to ensure their good coordination. The additional actuator(s) providing azimuth and/or elevation can operate separately from operation of the actuator of the first optical element and from operation of the actuator of the second optical element. These coordinated motions of the optical beam are particularly applicable to laser radar systems.

With these systems, the first optical element directs the beam to the target but does not need to be moved to produce scanning motions of the beam on the target. Rather, scanning motions are achieved by moving the second optical element. This movement of the second optical element is independent of motion of the first optical element.

In some embodiments the first and second optical elements are respective reflective optical elements. The first optical element can comprise a corner cube situated to receive the optical beam from a light source. Meanwhile, the second optical element can be situated to receive the optical beam from the corner cube and can be configured to return the beam to the corner cube as the second optical element is being moved by its actuator relative to the corner cube.

In other embodiments, the first optical element is a reflective optical element and the second optical element is a refractive optical element. For example, the first optical element can comprise a corner cube situated to receive the optical beam from a light source. Meanwhile, the second optical element is situated to receive the optical beam from the corner cube and configured to direct the beam to the target, even as the second optical element is being moved by its actuator relative to the corner cube to move the beam relative to the nominal propagation axis. This motion of the optical beam imparted by corresponding motion of the second optical element can be effectively a fine-scanning motion of the optical beam in a designated region of a target.

In yet other embodiments the first optical element comprises a corner cube situated to receive the optical beam from a light source. Meanwhile, the second optical element is situated to receive the optical beam from the corner cube and is configured to return the beam to the corner cube as the second optical element is being moved by its actuator relative to the corner cube to move the beam relative to the nominal propagation axis. For example, the actuator of the second optical element can be configured to move the beam by correspondingly tilting the second optical element relative to the corner cube.

In yet other embodiments the first optical element comprises a corner cube situated to receive the optical beam from a light source. Meanwhile, the second optical element comprises a refractive optical element that is situated to receive the light beam from the corner cube and is configured to direct the beam toward the target as the second optical element is being moved by its actuator relative to the corner cube to move the beam relative to the propagation axis. By way of example, the second optical element can be configured by its actuator to move substantially laterally to the nominal propagation axis.

In yet other embodiments the first optical element comprises a reflective optical element that receives the optical beam and reflects the beam toward the target. Meanwhile, the second optical element comprises a terminus of a flexible light conduit, such as an optical fiber, directing the optical beam to the first optical element. The terminus is coupled to the actuator, which is configured to move the terminus relative to the first optical element to move the beam relative to the nominal propagation axis.

Various embodiments summarized above can further comprise a transmitting system and a receiving system. The transmitting system is coupled to the processor and includes a light source, wherein the transmitting system produces and delivers at least one optical beam to the beam-shaping optical system. The receiving system is coupled to the processor and is configured to receive light, of the light beam, reflected from the target, and to determine a characteristic of the target based on the received light.

The system can further comprise a primary beam scanner and a secondary beam scanner. The primary beam scanner directs the optical beam, from the beam-shaping optical system, toward the target. Meanwhile, the secondary beam scanner comprises the beam-shaping optical system summarized above.

In these various embodiments the beam-scanning device can have as few as one movable optical element, which can be refractive or reflective optical element. The single optical element can be moved more quickly, more reliably, more accurately, and more efficiently to produce a desired scanning motion of the interrogation beam, compared to conventional systems.

Another aspect of this disclosure is directed to devices for scanning a substantially coherent light beam, as an interrogation beam, over a region of a target. An embodiment of such a device comprises a beam-shaping optical system configured to direct the interrogation beam along a nominal propagation axis to the region. The beam-shaping optical system comprises at least one adjustably situated optical element configured to vary a direction of the nominal propagation axis. A controller, coupled to the first adjustably situated optical element, is configured to establish an interrogation-beam scan path based upon an adjustment of the adjustably situated optical element. The beam-shaping optical system can further comprise a multiple-element lens configured to focus the interrogation beam in the region. The adjustable optical element comprises a lens element of the multiple-element lens, wherein the lens element is displaceable relative to an axis of the multiple-element lens.

The beam-shaping optical system can further comprise a lens configured to focus the interrogation beam in the region, and a return-reflective surface situated on a lens axis and configured to direct a light beam to the lens, wherein the return-reflective surface comprises the adjustable optical element. By way of example, the return reflective surface is tiltable with respect to the lens axis. The return reflective surface can be, for example, a mirror surface.

In other embodiments the beam-shaping optical system comprises a lens configured to focus the interrogation beam in the region and an optical fiber situated and configured to conduct light to the lens. In these configurations the adjustable optical element can be a terminus of the optical fiber, wherein adjustment of the fiber terminus end is a displacement of the fiber terminus relative to the lens axis.

Some embodiments further comprise an optical receiving system situated and configured to receive at least portions of the interrogation beam from the target. A processor can be coupled to the optical receiving system and configured to estimate at least one target range based on the received portions and the interrogation beam scan path.

In embodiments in which the beam-shaping optical system includes a beam-focusing lens, the adjustable optical element can comprise a prism situated to transmit the interrogation beam along the varying axis.

A beam-shaping optical system can include at least one adjustably situated optical element configured to vary the direction of the nominal propagation axis. A beam-scan controller can be coupled to the at least one adjustably situated optical element and be configured to establish a scan path for the interrogation beam based on the orientation of the beam-shaping optical system and on an adjustment of the at least one adjustably situated optical element. In some examples, the beam-shaping optical system includes a multi-element lens configured to focus the interrogation beam, wherein the adjustably situated optical element is an adjustable lens element of the multi-element lens. In representative examples, adjustment of the adjustably situated optical element includes displacing the adjustable lens element of the multi-element lens relative to a lens axis.

The beam-shaping optical system in various embodiments includes: (a) a lens configured to focus the interrogation beam and (b) a return-reflective surface situated on a lens axis and used so to direct an optical flux to the lens. In these embodiments the adjustably situated optical element can be the return-reflective surface (e.g., a mirror surface or a prism surface). Adjustment of the return-reflective surface can comprise tilting the surface relative to the lens axis. In other examples, the beam-shaping optical system includes: (a) a lens configured to focus the interrogation beam, and (b) an optical fiber coupling optical radiation to the lens. In these embodiments the adjustably situated optical element can be an optical-fiber end, wherein adjustment of the fiber end produces a displacement of the fiber end relative to the lens axis. In further examples, an optical receiver is configured to receive, from the target, at least portions of the interrogation optical beam. A processor coupled to the optical receiver estimates at least one target range or other target characteristic based on the received portions and on the scan path of the interrogation beam.

Another aspect of this disclosure is directed to methods, of which representative embodiments comprise establishing a scan direction of the interrogation beam using a primary scanner configured to selectively orient a beam-shaping optical system. The established beam-scan direction can be varied based on an adjustment of at least one optical element of the beam-shaping optical system so as to establish a scan path. In some embodiments, adjustment of the at least one optical element of the beam-shaping optical system comprises displacing a lens element of a lens configured to focus the shaped optical beam. Adjusting the at least one optical element of the beam-shaping optical system can comprise tilting a reflective surface that directs the shaped interrogation beam along a lens axis. In other examples, adjusting the at least one optical element of the beam-shaping optical system comprises displacing a fiber end associated with a fiber portion that routes optical radiation into the beam-shaping optical system. In further representative embodiments, the shaped optical beam is directed to a target. One or more characteristics of the target surface are determined based on a portion of the shaped interrogation beam that reflects from the target along a scan path. At least one of target distance or other target characteristic is associated with the scan path.

In some examples, an image of at least a portion of the target is formed based on a plurality of distances determined along the scan path of the interrogation beam. The distances correspond to a respective plurality of target locations. In still other examples, the beam-scan direction produced by the primary scanner is based on portions of the shaped interrogation beam received along the scan path from the target.

Exemplary apparatus comprise a beam-forming optical system configured to produce an interrogation beam that is focused at a target. A primary scanner determines a primary path of the interrogation beam based on the pointing direction of the beam-forming optical system. A secondary scanner can be configured to produce a scan path relative to the pointing direction. In some representative embodiments, the beam-shaping optical system includes a multi-element lens for focusing the interrogation beam. A secondary scanner can be configured to establish a scan path by displacing at least one element of the multi-element lens relative to a lens axis. In other examples, the beam-shaping optical system includes a beam-focusing lens and an optical fiber. The optical fiber is situated to deliver optical radiation from a radiation source to the beam-focusing lens to produce the focused interrogation beam. The secondary scanner displaces an end of the optical fiber relative to a lens axis of the beam-focusing lens to establish the scan path of the interrogation beam. In other examples, the beam-shaping optical system includes a beam-focusing lens and a return reflector. The beam-focusing lens and return reflector reflect a beam of optical radiation from a radiation source to the beam-focusing lens to produce the focused optical beam. The secondary scanner tilts the return reflector relative to a lens axis of the beam-focusing lens to establish the scan path of the interrogation beam. The beam-shaping optical system can include a beam-focusing lens and a wedge prism situated along an axis of the beam-focusing lens. In these examples the secondary scanner is configured to rotate the wedge prism relative to the lens axis to establish the scan path. A processor can be used to produce a surface map or determine other characteristics of a target based on portions of the focused interrogation beam that return along the scan path and are analyzed by the processor.

The foregoing and other features and aspects of the disclosed technology are set forth below with reference to the accompanying drawings.

### BRIEF DESCRIPTION OF THE DRAWINGS

FIG. 1 is a schematic diagram of a portion of laser radar system that includes an optical system configured to scan a laser beam (interrogation beam) over a region of interest on a target object (“target”).

FIGS. 2A-2B illustrate a mirror configured to perform scanning of the interrogation beam.

FIG. 3 is a schematic diagram illustrating a fiber support that scans the interrogation beam by displacing a fiber held by the fiber support.

FIG. 4 is a block diagram of a laser radar system that includes a lens element that can be displaced to produce a corresponding scan of the interrogation beam.

FIG. 5 is a block diagram of a method for evaluating a target using a scanned interrogation beam.

FIG. 6 is a schematic diagram of an optical radar or optical tracking system that includes a primary beam scanner and a secondary beam scanner.

FIG. 7 illustrates a secondary beam scanner that scans a beam based on a corresponding displacement of a holographic optical element or a Fresnel lens.

FIG. 8 is a block diagram of a representative method for tracking a tooling ball that is secured to a substrate or target.

FIG. 9 is a block diagram of a representative manufacturing system that includes a laser radar or other profile-measurement system, wherein the manufacturing system is used for manufacturing workpieces and for assessing whether the manufactured workpieces are defective or acceptable.

FIG. 10 is a block diagram of a representative manufacturing method that includes profile measurement for determining whether manufactured workpieces are acceptable, and if the manufactured workpieces are unacceptable whether any of them can be repaired.

FIG. 11 is a schematic diagram of a conventional laser radar system.

### DETAILED DESCRIPTION

The invention is described below in the context of representative embodiments that are not intended to be limiting in any way.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, apparatus, and methods are not limited to any specific aspect or feature or combinations thereof, nor do the disclosed systems, apparatus, and methods require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to a target or other object, an “upper” surface can become a “lower” surface simply by turning the target over. Nevertheless, it is still the same object.

The systems, apparatus, and methods described herein should not be construed as being limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation set forth herein are to facilitate explanation; but, the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

For convenience in the following description, the terms “light” and “optical radiation” refer to propagating electromagnetic radiation that is directed to one or more targets or other loci to be profiled, detected, or otherwise investigated. Such radiation can be referred to as propagating in one or more “beams” that typically are based on optical radiation produced by a laser. In addition, such beams can have a spatial extent associated with one or more laser transverse modes, and can be substantially collimated and/or focused. As used herein, a beam having a wavelength λ is “substantially collimated” if an associated beam divergence (or convergence) angular diameter β is less than about 0.05, 0.01, or 0.005. In some examples, a substantially collimated beam has a divergence or convergence such that a ratio of a beam diameter at a target to a beam diameter as emitted to the target is less than 2:1, 1.5:1 or 1.2:1. Alternatively, collimation can be associated with beams such that a source-to-target distance is less than about 0.5, 1.0, 2.0, or 4.0 times a Rayleigh range associated with the beam.

For convenience, beams are described as propagating along one or more axes. Such axes generally are based on one or more line segments so that an axis can include a number of non-colinear segments as the axis is bent or folded or otherwise responsive to mirrors, prisms, lenses, and other optical elements. The term “lens” is used herein to refer to a single refractive optical element (a singlet) or a compound lens that includes one or more singlets, doublets, or other elements. In some examples, beams are shaped or directed by refractive optical elements; but, in other examples, reflective optical elements such as mirrors are used, or combinations of refractive and reflective elements are used. Such optical systems can be referred to as dioptric, catoptric, and catadioptric, respectively. Other types of refractive, reflective, diffractive, holographic and other optical elements can be used as may be convenient.

Some described embodiments include a corner cube used as part of the beam-shaping system. For convenient illustration, such corner cubes are shown in some figures as two reflectors having reflective surfaces oriented at 90° to each other.

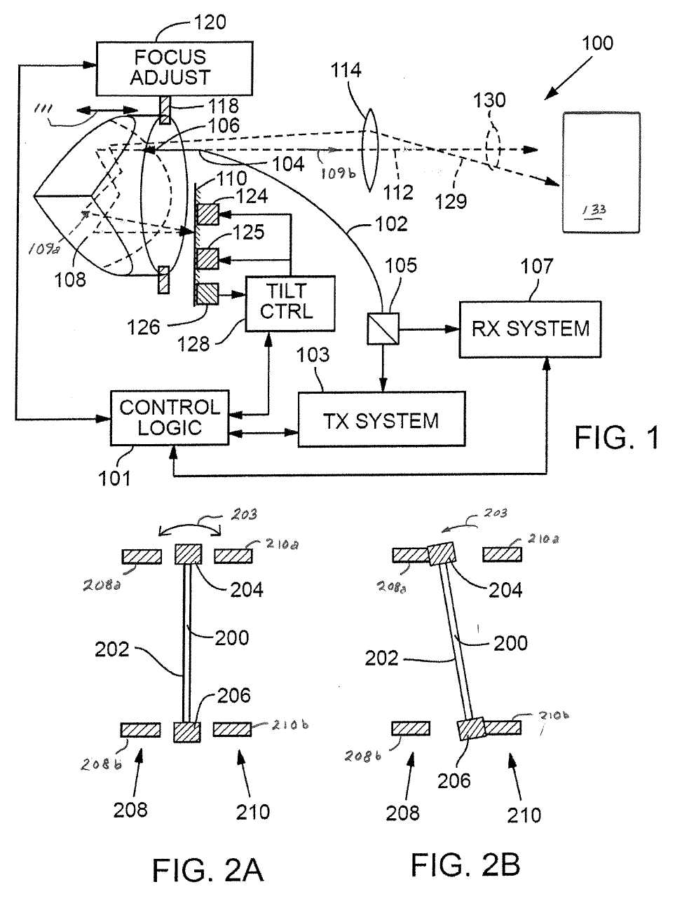

Relevant portions of a first representative embodiment of an optical system 100 particularly suitable for use as a laser radar system are illustrated in FIG. 1. The denotation “laser radar system” will be understood to encompass not only laser radar systems per se but also any of various other optical systems that project one or more optical beams to a target while providing scanning motion to the projected beam(s). An optical fiber 102 includes an emitter surface 104 that emits an optical beam 106 to a corner cube 108. The optical beam 106 is substantially collimated and destined to become a laser-radar “interrogation beam.” The optical fiber 102 is typically coupled to a transmitting (TX) system 103 via a beam splitter 105. The transmitting system 103 typically includes one or more lasers or other suitable light sources (not shown in FIG. 1). The corner cube 108 is mounted on a movable translation device, described below, for purposes of shaping and focusing the beam into an interrogation beam. Scanning motion of the interrogation beam is achieved by a scanning device that is separate from the corner cube and from the translation device and that does not rely upon movement of the corner cube to achieve beam scanning.

It is generally convenient to select the optical fiber 102 and the wavelength of the light beam such that the beam emitted by the optical fiber 102 propagates in a lowest-order mode of the fiber. Alternatively, in some embodiments, higher-order modes can be used.

The optical system of FIG. 1 can also be configured to produce an alignment beam in a similar manner as the interrogation beam. By way of example, the optical fiber 102 can be single-mode at about 1550 nm so that a 1550-nm beam destined to be the interrogation beam propagates through the optical fiber in a single, lowest-order mode, while a visible-wavelength beam destined to be the alignment beam propagates through the optical fiber in multiple (but nevertheless few) modes. A receiving (RX) system 107 is coupled to the optical fiber 102 via the beam splitter 105. The beam splitter 105 as shown is configured as a cubic beam splitter; alternatively, beam splitting can be achieved using one or more other components such as, but not limited to, fiber couplers.

The optical beam 106 emitted from the optical fiber 102 propagates to the corner cube 108, diverging at an angle that is based on approximately the numerical aperture of the optical fiber. The corner cube 108 directs the optical beam 106 to a return reflector 110, which produces therefrom a reflected beam 109a destined to be the interrogation beam 109b. The reflected beam 109a exits the corner cube 108 and propagates (as the interrogation beam 109b) along a nominal propagation axis 112 (parallel to, for example, a Cartesian z-axis) to a beam-shaping lens 114. The nominal propagation axis 112 can be bent or folded and hence is generally not a single straight line.

As noted, the corner cube 108 is mounted on a translation device (e.g., a stage or the like) 118 that is movable under the control of a focus controller (“focus adjust”) 120. By way of example, the translation device 118 in FIG. 1 is movable in at least the z-direction (i.e., direction of the nominal propagation axis 112; see arrows 111). Such motion of the translation device 118 is as directed by the focus controller 120 and serves to focus the interrogation beam 109b onto a target 133.

A controller (“control logic”) 101 is coupled to the transmitting system 103, the receiving system 107, the focus controller 120, and a tilt controller 128 (described below). The controller 101 is configured (e.g., by software programming) to perform various functions, such as but not necessarily limited to: (a) correcting certain optical characteristics of the interrogation beam 109b; (b) processing signals from one or more of the transmitting system 103, the receiving system 107, the focus controller 120, and the tilt controller 128; (c) adjusting focus of the interrogation beam 109b; and (d) tilting the return reflector 110 as required to impart a scanning motion of the interrogation beam. The tilt controller 128 is discussed later below.

In this embodiment the return reflector 110 is a portion of a beam-scanning device that scans or sweeps the interrogation beam independently of any motion of the translation device 118. This scanning or sweeping of the beam is the result of correspondingly tilting the beam, wherein beam tilting is achieved by correspondingly controlled tilting motions of the return reflector 110. Tilting the return reflector 110 in a controlled manner produces a scanned interrogation beam 109b as follows: As shown in FIG. 1, actuators 124, 125 are situated relative to the return reflector 110 so as, when the actuators are energized, to tilt the reflector 110 in a controlled manner about one or more tilt axes (not shown). The tilt axes are typically perpendicular to the nominal propagation axis 112. For example, in some embodiments, if the translation device 118 is movable along the z-axis, the tilt axes are the x-axis and y-axis. The actuators 124, 125, are coupled to the tilt controller 128 which is coupled to and under the control of the controller 101. The tilt controller 128 produces actuator-energization impulses according to control signals produced by the controller 101. Thus, the return reflector 110 is controllably tilted about its tilt axis (or axes) as required to direct the interrogation beam 109b to propagate along tilt propagation axes 129 (one such axis is shown). During beam scanning the tilt propagation axis 129 correspondingly changes relative to the nominal propagation axis 112. As a result, the interrogation beam 109b assumes a scanning displacement according to a selected scan pattern SP as the interrogation beam is incident on the target 133. Light returning from the target propagates through the lens 114 and optical fiber 102 to the beam splitter 105 to the receiving system 107, which includes at least one detector.

In this embodiment the transmitting system 103, optical fiber 102, corner cube 108, and beam splitter 105 are components of a “beam-producing system.” The corner cube 108, focus controller 120, and beam-shaping lens 114 are components of a “beam-shaping system.” The return reflector 110, actuated by the actuators 124, 125, constitutes a “beam-steering device” (also called a “beam-scanning device”). Whereas the beam-shaping system forms, shapes, and sends the interrogation beam to the target 133, the beam-steering device moves the beam in a scanning or sweeping manner as required for interacting with a target 133. The beam-steering device and beam-shaping system typically operate concurrently, but they can operate separately.

One or more encoders such as encoder 126 can be provided for measuring the tilt of the return reflector 110. By coupling the encoder(s) 126 to the controller 101, closed-loop adjustments of tilt of the return reflector 110 can be performed, as controlled by the controller 101. In some embodiments only a single actuator (e.g., item 124) is provided, rather than both actuators 124, 125, wherein a single actuator tilts the interrogation beam 109b on only a single axis rather than on two axes. Two actuators 124, 125 produce scanning of the interrogation beam 109b on two axes (e.g., x- and y-axes).

The actuators 124, 125, depending upon their configurations, tilt the reflector 110 in various respective ways. In some embodiments the actuators are configured as respective galvanometers that, when energized by the tilt controller 128, cause the return reflector 110 to tilt at periodic respective repetition rates (which can be the same or different). In other embodiments the tilt controller 128 commands the actuators 124, 125 to produce aperiodic scanning tilts of the return reflector 110. In yet other embodiments the return reflector 110 is tilted according to a raster, a spiral, or a W-shaped scan pattern SP. In any event, the return reflector 110 and its actuators 124, 125 are components of a beam-steering device.

The degree of scanning deflection of the return reflector 110 desirably is limited in one, two, or three dimensions. For example, in certain embodiments the return reflector 110 is located in a gap between opposing front and rear stops, as depicted generally in FIGS. 2A and 2B. In such embodiments the return reflector 110 can be mounted in a three-point manner, for example, wherein each of three mounting points is independently positionable at or between corresponding “front” and “rear” stops, thereby allowing the return reflector to be moved repeatedly to any of multiple 3-D orientations. In these and other embodiments the positions of the return reflector 110 can be predetermined and the maximum tilts can be fixed, thereby possibly eliminating the need for position-sensor(s) for determining and/or monitoring scan positions of the return reflector 110. The return reflector 110 can selectively be, at any moment in time, in one of a finite number of fixed positions that are measured and calibrated in advance.

FIG. 2A illustrates a representative example of a return reflector 200 configured to be tilted, by an actuator 124, 125, by any of various tilt angles (arrows 203) within predetermined tilt limits. The return reflector 200 has a reflective surface 202 and is secured by mounting points 204, 206 that are displaceable between a front stops 208a, 208b and rear stops 210a, 210b. Scanning motion of the return reflector 200 is controlled so that, at a first tilt maximum (shown in FIG. 2B), the mounting point 204 contacts the front stop 208a as the mounting point 206 contacts the rear stop 210b, while at a second tilt maximum the mounting point 204 contacts the front stop 208b as the mounting point 206 contacts the rear stop 210a. Periodic scanning of the beam is achieved by moving the return reflector in a correspondingly periodic manner between the first and second tilt maxima. FIG. 2A depicts the return reflector 200 situated mid-way between the stops 208, 210 and thus midway between corresponding tilt maxima. FIG. 2B depicts the return reflector 200 at maximum “downward” tilt (arrow 203). This embodiment is simple and reliable for producing regular, periodic tilting motions of the reflector 200 upward and downward (in the figure) between the stops 208, 210. A possible disadvantage is that the return reflector 200 is maximally tilted only to fixed, predetermined angles. (However, the distance between the stops 208, 210 can be made infinitely adjustable up to a maximum at which the mounting points 204, 206 no longer contact the stops 208, 210. A key advantage of these embodiments is that, for producing a scanned interrogation beam, moving the return reflector 200 involves moving much less mass than moved in conventional laser radar systems. Hence, this embodiment achieves more rapid and more accurate beam scanning than a conventional laser radar system.

In an alternative embodiment, scanning motion of the interrogation beam is achieved by correspondingly displacing the end of an optical fiber conducting a laser beam destined to be the interrogation beam. In other words, this alternative embodiment does not require scanning motion of a return reflector to produce a scanned interrogation beam. If a return reflector (similar to item 110) is used together with a corner cube (similar to item 108), the return reflector can be stationary.

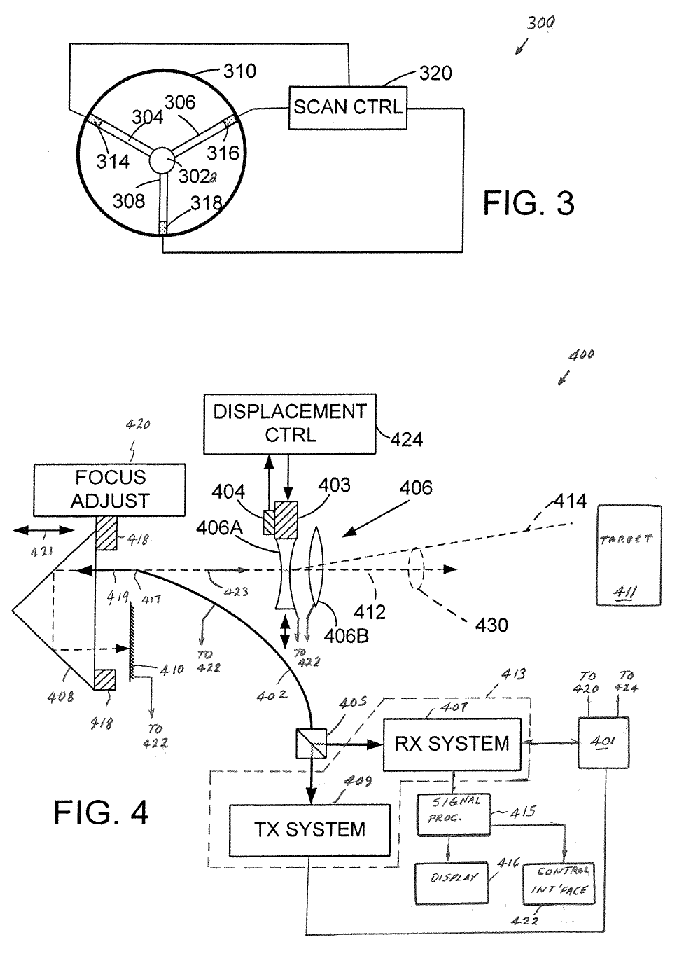

More specifically, the embodiment 300 shown in FIG. 3 includes an optical fiber 302 (viewed end-wise). A first end (not visible) of the optical fiber 302 is coupled to receive a laser beam from a source (not shown, but see item 102 in FIG. 1). Light of the laser beam propagates through the optical fiber 302 to the second end 302a of the optical fiber. From the second end 302a, the beam enters the corner cube (not shown). The second end 302a (seen in the figure) of the optical fiber is mounted, relative to the first end, in a manner by which beam-scan-producing motions of the second end can be produced. The motion of the second end of the optical fiber changes the angle of the beam leaving the optical system, which changes the angle of the focus axis. This change in angle changes the location of the focused spot on the target, allowing the focused spot to be scanned across a target. The resulting interrogation beam propagating from the corner cube to the target exhibits corresponding scanning motion. Hence, the second end 302a effectively serves as an optical element, distinct from the corner cube, that is movable to produce scanning motions of the interrogation beam.

The second end 302a of the optical fiber 302 is secured by supports 304, 306, 308 to a support member 310. In FIG. 3 the supports extend radially relative to the second end 302a, but this arrangement is not intended to be limiting. To produce motion of the second end 302a of the optical fiber 302, sufficient for producing corresponding scanning motion of the interrogation beam as focused onto the target, respective piezoelectric actuators 314, 316, 318 are situated between the support member 310 and the respective supports 304, 306, 308. The piezoelectric actuators 314, 316, 318 are coupled to a scan controller 320 configured (e.g., programmed) to deliver respective actuation potentials to the actuators 314, 316, 318. The actuation potentials cause respective dimensional changes in the respective actuators. The net result of the dimensional changes is a corresponding displacement of the second end 302a as required to achieve the desired scanning motion of the interrogation beam exiting the second end 302a. If desired, one or more displacement sensors (not shown) can be placed and utilized to produce data from which actual displacement of the second end 302a and/or of the interrogation beam can be calculated. The scan controller 320 can be configured to provide closed-loop control of interrogation-beam displacement, based on corresponding measured displacements of the optical fiber.

In the embodiment of FIG. 3, the second end 302a of the optical fiber as well as the actuators 314, 316, 318 controlling its position are components of a beam-steering device.

Turning now to FIG. 4, an optical system 400 is shown that is similar in some aspects to the embodiment shown in FIG. 1. Both embodiments deliver a beam of light via an optical fiber 102, 402, respectively, from a respective beam splitter 105, 405. The optical fiber 102, 402, respectively, in each embodiment includes an emitter surface 104, 417, respectively, that directs an optical beam 106, 419, respectively, to a respective corner cube 108, 408. In each embodiment the optical beam 106, 419, respectively, is destined to become an interrogation beam. The optical fiber 102, 402, respectively, in each embodiment is coupled to a respective transmitting (TX) system 103, 409 via the respective beam splitter 105, 405. The transmit system 103, 409 typically includes one or more lasers or other suitable light sources (not shown) that produce respective one or more interrogation beams.

Continuing further with FIG. 4, the optical system 400 includes a beam-focusing lens 406, which (in this embodiment) includes a rear negative lens 406A and a front positive lens 406B. One or both of the lenses 406A, 406B can be compound lenses such as cemented doublets or air-spaced lenses, if preferred. For producing scanning motion of the interrogation beam, the rear lens 406A is coupled to a displacement mechanism such as an actuator 403 (e.g., a piezoelectric device or other suitable device). The actuator 403 displaces the rear lens 406A laterally (perpendicularly to the nominal propagation axis 412), as directed by a displacement controller 424 to which the actuator 403 is coupled. By displacing the rear lens 406A using the actuator 403, a corresponding deflection of the interrogation beam is produced that causes the beam to propagate along an axis 414 that is not coincident with the axis 412. Repetitive, periodic displacement of the rear lens 406A in this manner produces a corresponding periodic deflection of the beam relative to the nominal propagation axis, which causes the interrogation beam to be repetitively scanned along an arc 430, or according to another desired scan pattern, on the target 411.

The FIG. 4 embodiment differs from the FIG. 1 embodiment principally in the means for scanning the interrogation beam. Both embodiments utilize an optical element that interacts with a beam destined to be the interrogation beam. In the FIG. 1 embodiment the optical element is reflective, namely the return reflector 110 that is caused to tilt by the tilt actuators 124, 125. In the FIG. 4 embodiment the optical element is refractive, namely the rear lens 406A that is caused to shift laterally by the actuator 403. Although the rear lens 406A can comprise multiple elements (e.g., a doublet or triplet), it is usually advantageous to specify the rear lens 406A as a singlet to reduce as much as possible the mass to be displaced for scanning the interrogation beam.

The scanning motion of the interrogation beam imparted by corresponding displacement of the rear lens 406A can be repetitive or variable. As shown in FIG. 4, the actuator 403 allows the rear lens 406A to be displaceable in one dimension orthogonal to the nominal axis 412. By adding a second actuator (not shown) situated and configured to produce movement of the rear lens 406A along a second axis orthogonally to the nominal axis 412, the interrogation beam can be displaced in a two-dimensional manner relative to the nominal axis 412 to provide two-dimensional scanning of the target 411. In any event, displacement of the rear lens 406A for scanning purposes can be detected and measured using a position sensor or displacement sensor 404. The rear lens 406A is not limited to a negative lens as shown; it alternatively can be, for example, a parallel plate. The scanning lens or scanning optics may have small refractive power, especially when the magnitude of tilt of the propagation axis 129 relative to the nominal propagation axis 112 is small.

As in the FIG. 1 embodiment, the embodiment of FIG. 4 also includes a return reflector 410 situated relative to the corner cube 408, a translation device 418, and a focus controller 420. The corner cube 408 is mounted on the translation device (e.g., a stage or the like) 418 that is movable under the control of the focus controller (“focus adjust”) 420. By way of example, the translation device 418 is movable in the z-direction (i.e., direction of the nominal propagation axis 412; see arrows 421). Such motion of the translation device 418 is as directed by the focus controller 420, serving to shape and focus the interrogation beam 423 onto a selected location on the target 411.

In the FIG. 4 embodiment the return reflector 410 can be stationary, in contrast to the return reflector 110 of the FIG. 1 embodiment 100, because the return reflector 410 is not used to produce scanning of the interrogation beam. The receiving system 407, transmitting system 409, focus controller adjuster 420, and displacement controller 424 can be coupled to and under the control of a controller 401 similar in many ways to the controller 101 in FIG. 1. The receiving system 407 and transmitting system 409 are respective portions of a transmit/receive system 413.

In the embodiment 400 as well as in other embodiments disclosed herein, scattered, reflected, or other light produced by interaction of the scanned interrogation beam with the target 411 is returned to the transmit/receive system 413. Detected signals based on the portions of the interrogation beam that are returned from the target 411 are coupled to a signal processor 415 for use in forming surface images, contour maps, or other representations of the target 411 that can be provided to a display 416. In some examples, the detected signals can be processed to provide assessments of the target surface without having to produce a displayed image. The scanning elements (e.g., optical fiber 402, lenses 406A, 406B, return reflector 410, and signal processor 415) can be coupled generally to a control interface 422 so that beam scanning can be correlated with a corresponding detected signal. The control interface 422 can also allow a user to input selected scan ranges, scan rates, surface data assessments, and/or other measurement configurations. For example, positions and tilts of the scanning elements and locations of the scanned interrogation beam can be monitored during scanning, wherein the monitoring is performed using one or more encoders or other appropriate monitoring devices (not shown). In other examples, detections of beam deflection or associated scan-element position are not needed because open-loop scan performance is stable and/or calibrations can be performed at occasional convenient intervals. Nevertheless, real-time tracking of beam scan and the associated scan elements can be advantageous.

In the embodiment of FIG. 4, the lens 406A and actuator 403 are components of a beam-steering device.

Some advantages of the embodiments disclosed herein include scanning and/or sweeping of the interrogation beam in a manner that is independent of other motions. This allows the scanning and/or sweeping motions (i.e., scanning beam “steering” motions) of the interrogation beam to be performed without having to move the relatively large masses of other portions of the laser radar system. This does not mean that the laser radar system necessarily lacks respective subsystems for achieving motions other than beam-steering; rather, it simply means that the beam-steering motions are produced in a manner that is independent of those other motions. Consequently, component(s) responsible for beam steering can be made relatively small and low in mass, and beam-steering can be achieved more easily and more quickly than in conventional laser radar systems. For example, in the various embodiments the interrogation beam(s) can be rapidly scanned in the vicinity of a given measurement point on the surface of the target. The beam-steering device can be used to produce, for example, spiral or w-scans of the interrogation beam. Different measuring strategies can be implemented such as, for example, averaging a number of points around a selected measurement point on the target to obtain a better estimated value, or determining target-surface orientation on a small patch of the target. Monitoring return-signal intensity as the interrogation beam moves scanningly relative to the target can indicate, for example, centering of a tooling ball relative to the interrogation beam. These features can increase measurement quality, accuracy, and/or rate, and can be used as a tracking function. Consequently, a laser radar system including these features can mimic a laser tracker from a functionality perspective.

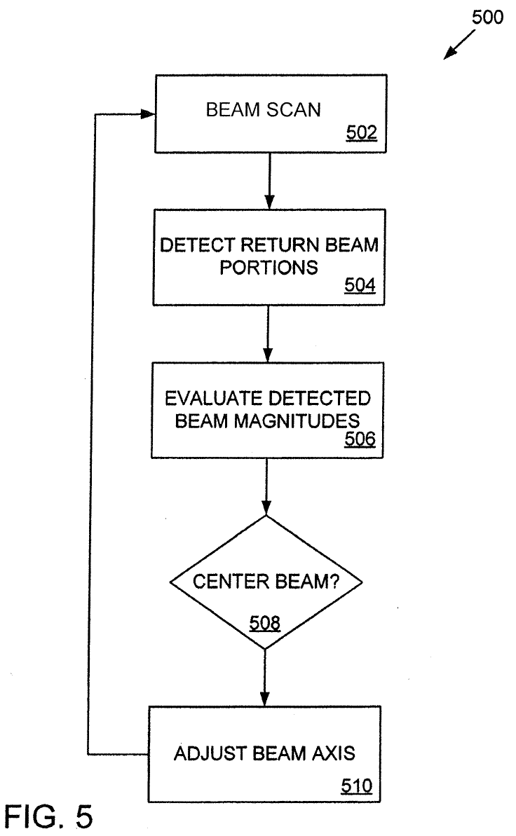

A representative embodiment of a measurement method is illustrated in FIG. 5. At 502, an interrogation beam is scanned along a pre-selected circular arc or other geometrical scan pattern on the target, as achieved by operation of the beam-steering device. At 504, portions of the interrogation beam returning from the target (“returning beam”) are detected, and the respective magnitudes of one or more parameters of the returned beam are estimated for the entire selected scan pattern or for a selected portion thereof. At 506, the magnitudes of the parameters are evaluated to determine possible corresponding features on the surface of the target. In some examples, spherical or circular target features are of interest, wherein the respective center locations of circular or spherical features on the target can be estimated, based on the signal magnitudes, using a circular scan pattern. If beam centration is determined to be of interest at 508, the beam position (axis) is adjusted, as required, at 510. Typically, beam adjustment is accomplished by moving components other than those of the beam-steering system. For example, if the laser radar system is mounted on one or more movable stages or analogous mountings, beam adjustment may be made by shifting one or more of such stages. As another example, beam adjustment may be achieved by adjusting the beam-shaping system. After beam adjustment, beam scanning continues at 502.

Measurements produced by execution of the method 500 can be used to produce an average measurement over a region of a target surface. Alternatively or in addition, the measurements can be analyzed to determine surface-feature orientations at a measurement location. By monitoring the signal intensity of light returning from a scan of a region on the target, deviations from a center location or other particular location on the target can be estimated so that the interrogation beam can be maintained in alignment with a specific target-surface location. In other examples, beam scanning as disclosed above can be used to increase measurement quality, measurement accuracy, and/or measurement rate, or used to track particular surface features. In some examples, the disclosed fine-scanning can be used exclusively.

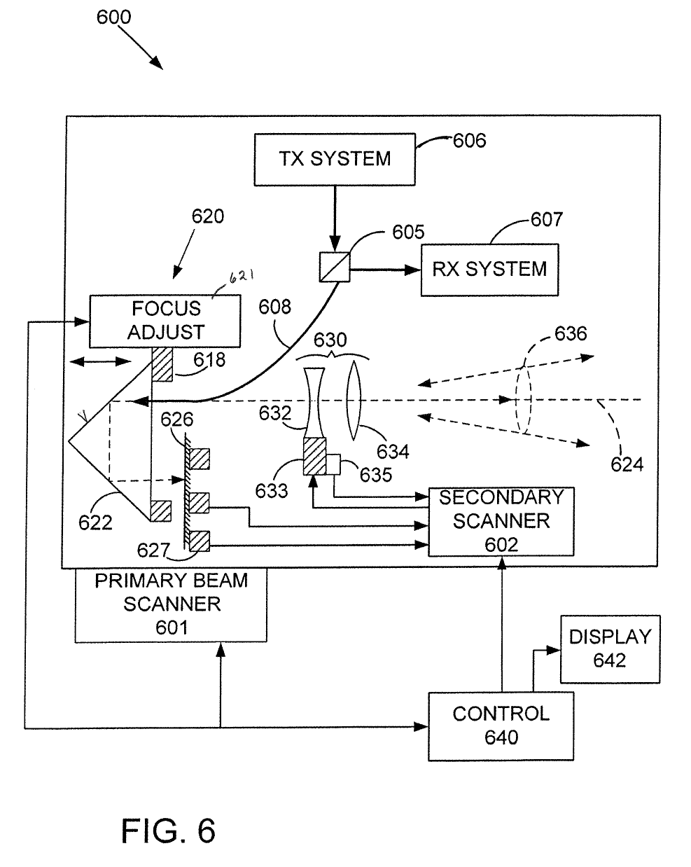

FIG. 6 depicts an embodiment of an optical system 600 that includes a primary beam scanner 601 and a secondary beam scanner 602. The system 600 further includes an optical transmitting (“TX”) system 606 that typically comprises one or more laser sources (e.g., laser diodes), each producing a respective optical beam. The TX system 606 also includes respective laser-driver and laser-control circuitry for the laser sources. The TX system 606 directs an optical beam to an optical fiber 608. A receiving (“RX”) system 607 receives, from the optical fiber 608, portions of the interrogation beam returning from the target (target not shown). The RX system 607 typically includes one or more photodetectors. Exemplary photodetectors include but are not limited to photodiodes, avalanche photodiodes, and photomultipliers. As shown in FIG. 6, a beam splitter 605 couples optical radiation to the TX system 606 and RX system 607. Alternatively to the beam splitter, another light-coupling device can be used, such as but not limited to a fiber splitter or other optical beam-routing device.

This embodiment includes a focus adjuster 620 serving as a respective portion of a beam-shaping system. The focus adjuster 620 includes a corner cube 622 that can be controllably translated along a nominal propagation axis 624 as commanded by a “focus adjust” controller 621. The focus adjuster 620 also includes a return reflector 626 that is tiltable similarly to the return reflector 110 of the first embodiment. Tilt of the return reflector 626 is controllably achieved using a secondary beam scanner 602 coupled to one or more actuators 627. The beam-shaping system also comprises a lens 630 including a first lens 632 and a second lens 634. As shown in FIG. 6, the first lens 632 is coupled to an actuator 633 that selectively displaces the lens relative to the nominal propagation axis 624 in response to a command from the secondary beam scanner 602. The secondary beam scanner 602 thus achieves scanning propagation of the interrogation beam along a scan path 636 or other trajectory by causing appropriate motion of the first lens 632, the return reflector 626, or both. Thus, the secondary beam scanner 602 together with the actuators 627, 633, return reflector 626, and lens 632 are components of a beam-steering system of this embodiment.

This embodiment also includes a primary beam scanner 601. By way of example, the primary beam scanner 601 directs the interrogation beam to a selected region of the target. The secondary beam scanner 602 then causes the interrogation beam to move in a scanning manner, according to a selected beam-scanning trajectory, in the selected region. A scan-control system 640 is configured to provide scan instructions to the primary beam scanner 601 to direct the interrogation beam to the desired region on the target, and instructions to the secondary beam scanner 602 to scanningly move the interrogation beam according to a selected scan pattern. The control system 640 can also be coupled to the TX system 606 and to the RX system 607 to achieve regulation of, for example, interrogation-beam power, wavelength, and/or or other characteristic(s) and to process data associated with the returning beam to produce target-surface profiles and/or to track selected features of the target surface. In some embodiments a display 642 is coupled to the control system 640 so as to display the data (or display other information) for use by a user.

Although a particular arrangement of components is shown in FIG. 6, other arrangements alternatively can be used. For example, one or more components such as the TX system 606, the RX system 607, and/or the secondary beam scanner 602 can be mounted to a common mechanical support (not shown). Further alternatively, these components can be mechanically separated from each other and coupled together optically using flexible optical fibers and electrical cables so that the primary beam scanner 601 can control the orientations of beam-forming and beam-shaping components only while the secondary beam scanner 602 controls scanning motions of the interrogation beam. One or more encoders (e.g., an encoder 627 for the return reflector and/or an encoder 635 for the lens 632) can be provided and coupled so that beam tilts and/or other scanning displacements produced as instructed by the secondary beam scanner 602 can be sensed and used by the control system 640 for target characterization or for achieving closed-loop control of the secondary beam scanner.

The receiving system 607 detects light of the interrogation beam that is returning from the target. The receiving system 607 also can also be used to produce one or more optical reference beams (for simplicity of illustration, these features are not shown in FIG. 6).

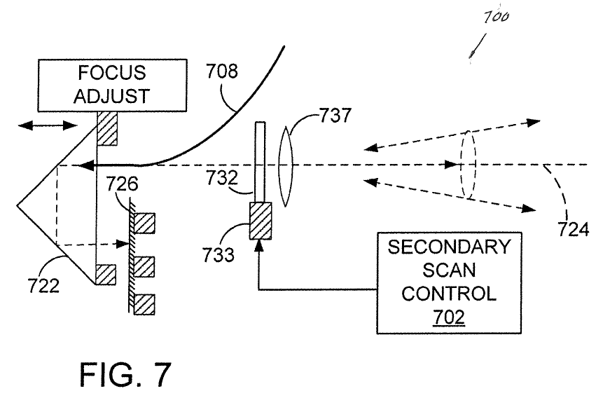

FIG. 7 depicts an exemplary embodiment of a laser-tracking system 700 configured as a beam-steering system. A beam-forming lens 737 is situated along a nominal propagation axis 724 to receive an optical light flux (one or more beams) from a laser diode (not shown) or the like via an optical fiber 708. The light flux is directed by the optical fiber 708 to a corner cube 722 and to a return mirror 726. From the return mirror 726 the light flux (in the form of an interrogation beam) passes from the corner cube 722 to an objective lens 732 that directs the beam onto a region of the target (not shown). To achieve scanning of the interrogation beam, a secondary scan controller 702 is coupled to an electromagnetic actuator such as a voice-coil motor or piezoelectric actuator 733. One or more actuators 733 are used, each being configured to displace a central or other portion of the objective lens 732 relative to the axis 724. In the embodiment shown in FIG. 7, the objective lens 732 can be a holographic optical element or a Fresnel lens, for example. The objective lens 732 is coupled to and responsive to the actuator(s) 733. The actuator(s) 733 desirably displace the objective lens 732 in two directions that are orthogonal to the axis 724, thereby achieving two-dimensional scanning of the interrogation beam. Encoder(s) or position sensor(s) 735 can be coupled to the objective lens 732 to assess displacements of the objective lens 732 as well as the resulting displacements of the interrogation beam. In some examples, the objective lens 732 can include a holographic, diffractive, or Fresnel lens. The objective lens 732 can comprise one or more refractive lens elements such as the lens element 737.

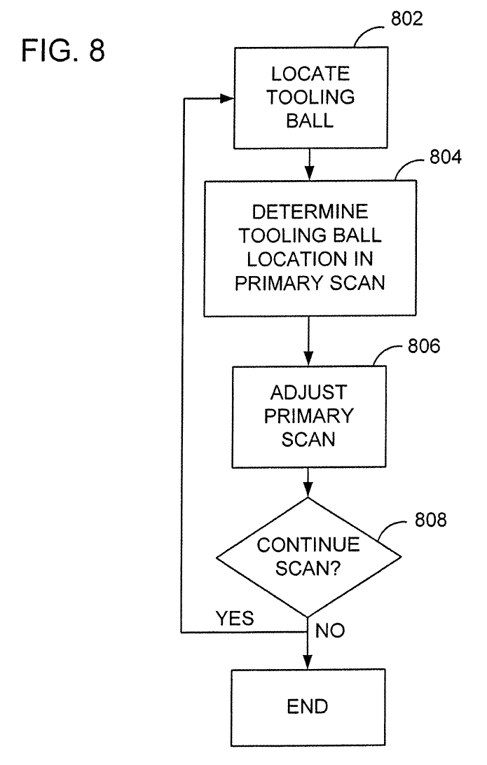

FIG. 8 illustrates a representative method of tracking a tooling ball secured to a substrate or target. One or more tooling balls can be secured to a target to provide reference points for coordinate determinations. Tooling balls generally include a reflective ball-shaped surface to provide ample reflection of an interrogation beam of a laser-based measurement apparatus such as a laser radar system.

The system shown in FIG. 7 can be used to determine the respective locations of one or more “tooling balls” on the surface of the target. This determination can be made according to the method diagrammed in FIG. 8. At 802 the location of a tooling ball on the target surface is identified and recorded, based on returned portions of a scanned interrogation beam reflected from the tooling ball. The beam can be scanned in any of a variety of patterns such as circles, spirals, w's, or zig-zags for tracking the tooling ball.

At 804, the identified location of the tooling ball is evaluated to determine its position relative to a primary scan. The primary scan is adjusted at 806 so that the tooling-ball location is at a preferred location relative to the primary scan. (Typically, the primary scan is adjusted so that the tooling-ball location is approximately centered within the range of the primary scan.) At 808, a determination is made of whether to perform additional scanning.

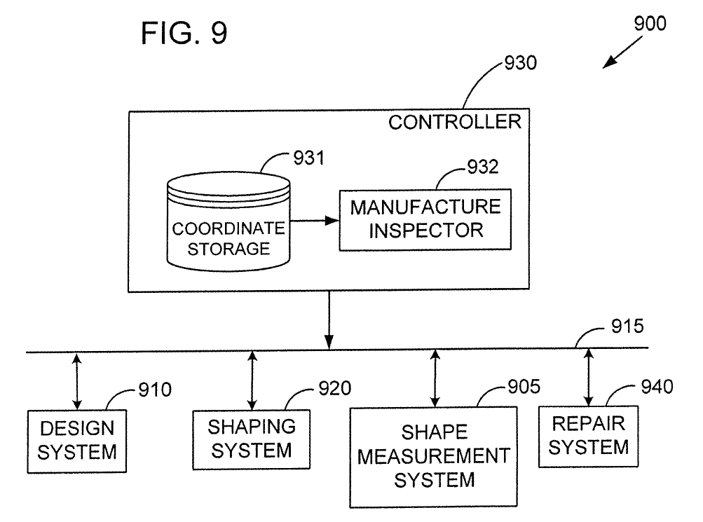

FIG. 9 illustrates a representative manufacturing system 900 suitable for producing one or more components of a ship, airplane, or other system or apparatus, and for evaluating and possibly reprocessing the components after manufacture. The system 900 typically includes a shape- or profile-measurement system 905 such as the laser radar system 100 discussed above. The manufacturing system 900 also includes a design system 910, a shaping system 920, a controller 930, and a repair system 940. The controller 930 includes coordinate storage 931 configured to store coordinates (coordinates obtained by measurements and/or established design coordinates) or other parametric characteristic(s) of the component(s). The coordinate storage 931 is generally a computer-readable medium such as a hard disk, a random access memory, or other memory device. Typically, the design system 910, the shaping system 920, the shape-measurement system 905, and a repair system 940 communicate with each other via a communications bus 915 using a network protocol.

The design system 910 is configured to produce design information corresponding to shape, coordinates, dimensions, and/or other parametric features of a structure to be manufactured, and to communicate the produced design information to the shaping system 920. The design system 910 can also communicate design information to the coordinate storage 931 of the controller 930 for storage. Design information typically includes data corresponding to the coordinates of at least some features of a structure to be manufactured.

The shaping system 920 is configured to produce a structure based on the design information from the design system 910. The shaping processes performed by the shaping system 920 can include casting, forging, cutting, or other suitable process. The shape-measurement system 905 is configured to measure the coordinates of one or more features of the manufactured structure and to communicate the information (e.g., measured coordinates or other information related to the shape of the structure) to the controller 930.

A manufacture inspector 932 of the controller 930 is configured to obtain design information from the coordinate storage 931. The manufacture inspector 932 also compares information (e.g., coordinates or other shape information received from the profile-measuring system 100) with design information read out from the coordinate storage 931. The manufacture inspector 932 is generally configured as a processor and a series of computer-executable instructions that are stored in a the controller 930 in a tangible computer-readable medium such as a random access memory, a flash drive, a hard disk, or other memory-storage device. Based on a comparison of design data versus actual structural data, the manufacture inspector 932 can determine whether the manufactured structure meets specification in terms of, for example, the design information. The determinations are generally based at least in part on one or more design tolerances that can be stored in the coordinate storage 931. In other words, the manufacture inspector 932 can determine whether the manufactured structure is defective or non-defective. If the structure is not shaped in accordance with design specifications (and hence is defective), then the manufacture inspector 932 determines whether the structure is repairable. If the structure is repairable, then the manufacture inspector 932 identifies the defective portions or regions of the structure and provides suitable coordinates or other data by which to perform repair. The manufacture inspector 932 is also configured to produce repair instructions and/or repair data and to forward the instructions and/or data to the repair system 940. The repair data can include locations requiring repair, extent of re-shaping required, or other repair data. The repair system 940 is configured to process defective portions of the manufactured structure based on the repair data.

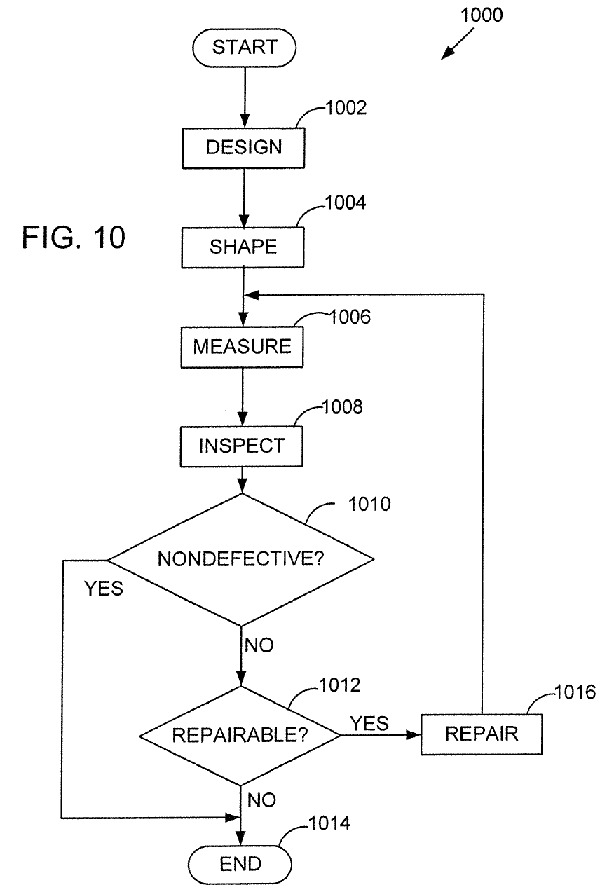

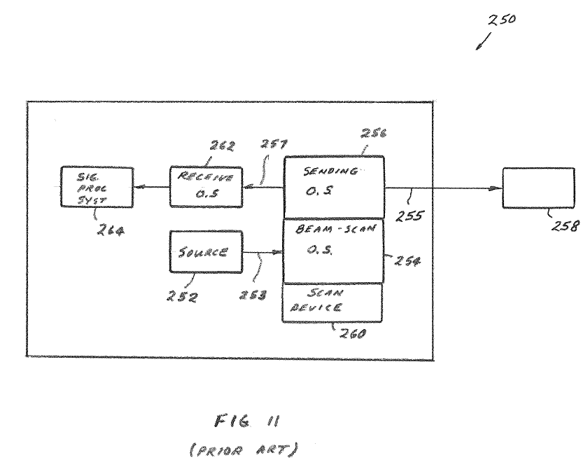

FIG. 10 is a flowchart showing a representative manufacturing method 1000 incorporating a manufacturing system such as the embodiment shown in FIG. 8. At 1002, design information is obtained or created corresponding to the shape or topography of a structure to be manufactured. At 1004, the structure is manufactured or “shaped” based on the design information. At 1006, coordinates, dimensions, or other features of the manufactured structure are measured using a profile-measurement system such as any of the laser radar embodiments described above to obtain shape or other profile information pertaining to the structure as manufactured. At 1008, the structure is inspected based on a comparison of actual (as-manufactured) versus design (as-specified) dimensions, coordinates, manufacturing tolerances, or other structural parameters. At 1010, if the manufactured structure is determined to be non-defective (within specification), the structure is regarded as “acceptable” and processing ends at 1014. If the structure is determined to be defective (out of specification) at 1010 (by, for example, the manufacture inspector 932 of the controller 930 shown in FIG. 8), then at 1012 a determination is made of whether the offending structure is repairable. If the structure is repairable, it is reprocessed or repaired at 1016, and then measured, inspected, and reevaluated at 1006, 1008, 1010, respectively. If the structure is determined to be non-repairable at 1012, the process ends at 1014.

According to the embodiment of FIG. 10, a manufactured structure can be evaluated using a profile-measurement system to measure or assess coordinates or other features of a manufactured structure. Thus, the structure can be evaluated to determine whether the structure is defective or not. If the structure is determined to be defective but repairable or reprocessable, a reprocessing process can be performed. By repeating measurement, inspection, and evaluation, defective parts can be readily identified and reprocessed, while structures that are defective and non-repairable can be set aside or discarded. The particular systems and methods of FIGS. 9-10 are exemplary only, and other arrangements alternatively can be used.

In the embodiment of FIG. 10, the manufacturing system 1000 can include a profile-measurement system comprising a laser radar 100, a design system 910, a shaping system 920, a controller 930 configured to determine whether a structure is acceptable (inspection apparatus), and a repair system 940. However, other systems and methods can be used, and the exemplary embodiments of FIGS. 9 and 10 are provided for convenient illustration and should not be regarded as limiting the scope of the this disclosure. We claim all that is encompassed by the appended claims.

Whereas the invention has been described in the context of multiple representative embodiments, it will be understood that it is not limited to those embodiments. On the contrary, it is intended to cover all modifications, alternatives, and equivalents as may be including within the spirit and scope of the invention, as defined by the appended claims.

We claim:

1. An optical system, comprising:
a beam-shaping optical system including a first movable optical element and a second movable optical element, the first optical element forming and directing an optical beam along a nominal propagation axis from the beam-shaping optical system to a target, and the second optical element including an actuator by which the second optical element is movable relative to the first optical element; and
a controller coupled at least to the actuator of the second optical element and configured to induce motion, by the actuator, of the second optical element to move the optical beam, as incident on the target, relative to the nominal propagation axis.

2. The system of claim 1, wherein the second optical element is movable separately from movement of the first optical element.

3. The system of claim 1, wherein the actuator of the second optical element causes the light beam to undergo a scanning motion, relative to the nominal propagation axis.

4. The system of claim 1, wherein the first optical element is adjustable to focus the optical beam as incident on the target.

5. The system of claim 1, wherein the first and second optical elements are respective reflective optical elements.

6. The system of claim 5, wherein:
the first optical element comprises a corner cube situated to receive the optical beam from a light source; and
the second optical element is situated to receive the optical beam from the corner cube and configured to return the beam to the corner cube as the second optical element is being moved by its actuator relative to the corner cube.

7. The system of claim 1, wherein the first optical element is a reflective optical element and the second optical element is a refractive optical element.

8. The system of claim 7, wherein:
the first optical element comprises a corner cube situated to receive the optical beam from a light source; and
the second optical element is situated to receive the optical beam from the corner cube and configured to direct the beam to the target as the second optical element is being moved by its actuator relative to the corner cube to move the beam relative to the nominal propagation axis.

9. The system of claim 1, wherein:
the first optical element comprises a corner cube situated to receive the optical beam from a light source; and
the second optical element is situated to receive the optical beam from the corner cube and configured to return the beam to the corner cube as the second optical element is being moved by its actuator relative to the corner cube to move the beam relative to the nominal propagation axis.

10. The system of claim 9, wherein the actuator of the second optical element moves the beam by correspondingly tilting the second optical element relative to the corner cube.

11. The system of claim 1, wherein:
the first optical element comprises a corner cube situated to receive the optical beam from a light source; and
the second optical element comprises a refractive optical element situated to receive the light beam from the corner cube and configured to direct the beam toward the target as the second optical element is being moved by its actuator relative to the corner cube to move the beam relative to the propagation axis.

12. The system of claim 11, wherein the second optical element is configured by its actuator to move substantially laterally to the nominal propagation axis.

13. The system of claim 1, wherein:
the first optical element comprises a reflective optical element that receives the optical beam and reflects the beam toward the target; and
the second optical element comprises a terminus of a flexible light conduit directing the optical beam to the first optical element, the terminus being coupled to the actuator, which is configured to move the terminus relative to the first optical element to move the beam relative to the nominal propagation axis.

14. The system of claim 1, further comprising a beam-producing system that produces the optical beam.

15. The system of claim 1, further comprising:
a transmitting system coupled to the processor and including a light source, the transmitting system being configured to produce and deliver at least one optical beam to the beam-shaping optical system; and
a receiving system coupled to the processor and configured to receive light, of the light beam, reflected from the target, and to determine a characteristic of the target based on the received light.

16. The system of claim 1, further comprising a primary beam scanner and a secondary beam scanner, the primary beam scanner being configured to direct the optical beam, from the beam-shaping optical system, toward the target, and the secondary beam scanner comprising the beam-shaping optical system.

17. A device for scanning a substantially coherent light beam, as an interrogation beam, over a region of a target, the device comprising:
a beam-shaping optical system configured to direct the interrogation beam along a nominal propagation axis to the region, the beam-shaping optical system comprising at least one adjustably situated optical element configured to vary a direction of the nominal propagation axis; and
a controller coupled to the first adjustably situated optical element, the controller being configured to establish an interrogation-beam scan path based upon an adjustment of the adjustably situated optical element.

18. The device of claim 17, wherein:
the beam-shaping optical system further comprises a multiple-element lens configured to focus the interrogation beam in the region; and
the adjustable optical element comprises a lens element of the multiple-element lens, the lens element being displaceable relative to an axis of the multiple-element lens.

19. The device of claim 18, wherein the beam-shaping optical system further comprises:
a lens configured to focus the interrogation beam in the region; and
a return-reflective surface situated on a lens axis and configured to direct a light beam to the lens, wherein the return-reflective surface comprises the adjustable optical element.

20. The device of claim 19, wherein the return reflective surface is tiltable with respect to the lens axis.

21. The device of claim 20, wherein the return reflective surface is a mirror surface.

22. The device of claim 17, wherein:
the beam-shaping optical system comprises a lens configured to focus the interrogation beam in the region and an optical fiber situated and configured to conduct light to the lens;
the adjustable optical element comprises is a terminus of the optical fiber; and
adjustment of the fiber terminus end is a displacement of the fiber terminus relative to the lens axis.

23. The device of claim 17, further comprising:
an optical receiving system situated and configured to receive at least portions of the interrogation beam from the target; and
a processor coupled to the optical receiving system and configured to estimate at least one target range based on the received portions and the interrogation beam scan path.

24. The device of claim 17, wherein:
the beam-shaping optical system includes a beam-focusing lens; and
the adjustable optical element comprises a prism situated to transmit the interrogation beam along the varying axis.

25. A method, comprising:
establishing an optical beam scan direction with a primary scanner configured to selectively orient a beam-shaping optical system; and
varying the established beam-scan direction based on an adjustment of at least one optical element of the beam-shaping optical system to establish a scan path.

26. The method of claim 25, wherein the adjustment of the at least one optical element of the beam-shaping optical system is a displacement of a lens element of a lens configured to focus the shaped optical beam.

27. The method of claim 25, wherein the adjustment of the at least one optical element of the beam-shaping optical system is a tilt of a reflective surface situated to direct an optical beam along a lens axis.

28. The method of claim 25, wherein the adjustment of the at least one optical element of the beam-shaping optical system is a displacement of a fiber end associated with a fiber portion situated to couple optical radiation into the beam-forming optical system.

29. The method of claim 25, further comprising:
directing the shaped optical beam to a target; and
based on a portion of the shaped optical beam received from the target along the scan path, determining at least one target characteristic associated with the scan path.

30. The method of claim 29, further comprising forming an image of at least a portion of the target based on plurality of distances determined along the scan path and associated with a corresponding plurality of target locations.

31. The method of claim 25, further comprising tracking a target feature based on portions of the shaped optical beam received from the target along the scan path.

32. An apparatus, comprising:
a beam-forming optical system configured to produce an optical beam focused on a target;
a primary scanner configured to determine a primary beam path based on an orientation of the beam-forming optical system; and
a secondary scanner configured to establish a scan path with respect to the orientation of the beam-forming optical system.

33. The apparatus of claim 32, wherein:
the beam-forming optical system includes a multi-element beam-focusing lens; and
the secondary scanner is configured to displace at least one element of the multi-element lens with respect to a lens axis to establish the scan path.

34. The apparatus of claim 32, wherein:
the beam-forming optical system includes a beam-focusing lens and an optical fiber situated to deliver optical radiation from a radiation source to the beam-focusing lens to produce the focused optical beam; and
the secondary scanner is configured to displace a terminus of an optical fiber relative to a lens axis of the beam-focusing lens to establish the scan path.

35. The apparatus of claim 32, wherein:
the beam-forming optical system includes a beam-focusing lens and return reflector situated to reflect optical radiation from a radiation source to the beam-focusing lens to produce the focused optical beam; and
the secondary scanner is configured to tilt the return reflector relative to a lens axis of the beam-focusing lens to establish the scan path.

36. The apparatus of claim 32, wherein:
the beam-forming optical system includes a beam-focusing lens and wedge prism situated along an axis of the beam-focusing lens; and
the secondary scanner is configured to rotate the wedge prism with respect to the lens axis to establish the scan path.

37. The apparatus of claim 32, wherein:
the beam-forming optical system includes a beam-focusing lens and tilted return mirror situated along an axis of the beam-focusing lens; and
the secondary scanner is configured to rotate the return mirror with respect to the axis to establish the scan path.

38. The apparatus of claim 32, further comprising a processor coupled and configured to provide a surface map of a target based on portions of the focused optical beam returned along the scan path.

39. The apparatus of claim 32, further comprising a scan controller configured to adjust the primary scanner and the secondary scanner so that the established scan path tracks a target feature.

40. A laser radar apparatus, comprising:
an optical fiber situated and configured to emit an optical beam along an axis;
a corner cube situated along the axis and configured to receive the emitted optical beam;
a displacement stage coupled to the corner cube and configured to displace the corner cube along the axis;
a return reflector situated along the axis and configured to receive the emitted optical beam from the corner cube and reflect the emitted optical beam as a returned beam to the corner cube;
a beam-forming lens situated along the axis to receive the returned beam from the corner cube and produce an interrogation beam;
a focus controller coupled to the displacement stage and configured to adjust a separation of the corner cube and the beam-forming lens so as to focus the interrogation beam at a selected target distance;
a primary beam scanner configured to direct the axis toward a selected target location; and
a secondary beam scanner coupled to at least one of the optical fiber, the return reflector, and one or more lens elements of the beam-forming lens so as to produce an angular deviation of the interrogation beam with respect to the axis.

41. The apparatus of claim 40, further comprising:
an optical receiving system configured to detect at least portions of the interrogation optical beam returned from a target; and
a processor coupled to the optical receiving system and configured to determine a target characteristic for at least a portion of the target, based at least on the detected portions of the interrogation optical signal and the angular deviation of the interrogation beam.

42. The apparatus of claim 41, wherein the target characteristic is surface topography of the target.

43. The apparatus of claim 40, wherein the optical receiving system is configured to detect at least a portion of the interrogation beam returned from the target to the optical fiber.

44. The apparatus of claim 40, wherein the secondary beam scanner is coupled to displace the optical fiber relative to the axis, and to tilt the return reflector relative to the axis, or to displace a lens element of the beam-forming lens to define the scan path.

45. A laser radar system, comprising:
a source of a substantially collimated optical beam;
a beam-shaping device including a respective movable optical element, a beam-shaping controller, and a first actuator configured to move, as controlled by the beam-shaping controller, the respective optical element to shape the optical beam for sending as an interrogation beam to a target;
a beam-scanning device comprising a respective movable optical element, a beam-scanning controller, and a second actuator configured to move, as controlled by the beam-scanning controller, the respective optical element to move the interrogation beam in a scanning manner;
wherein motion of the respective optical element of the beam-scanning device is independent of motion of the beam-shaping device.

46. The system of claim 45, wherein:
the respective optical element of the beam-shaping device is a corner cube; and
the respective optical element of the beam-scanning device is a return reflector situated to receive a portion of the optical beam from the corner cube and to reflect the portion back into the corner cube as the return reflector is moved by the second actuator independently of motion of the corner cube by the first actuator.

47. The system of claim 45, wherein:
the respective optical element of the beam-shaping device is a corner cube; and
the respective optical element of the beam-scanning device is a lens element situated to direct the optical beam as the interrogation beam to the target.

48. The system of claim 45, wherein:
the respective optical element of the beam-shaping device is a corner cube; and
the respective optical element of the beam-scanning device is an optical fiber having a terminus from which the optical beam is emitted to the corner cube as the terminus is moved by the second actuator independently of motion of the corner cube by the first actuator.

49. The system of claim 45, wherein the beam-scanning device comprises primary and secondary beam scanners configured to cooperatively direct the interrogation beam to the target as the interrogation beam is scanned by the beam-scanning device according to a preset beam-scan pattern.

50. A laser radar system, comprising:
a beam-shaping optical system including first and second movable optical elements, the first optical element forming and directing a beam of substantially coherent light along a nominal propagation axis from the beam-shaping optical system to a target, and the second optical element including a respective activator by which the second optical element is movable relative to the first optical element to cause the beam to move in a predetermined scanning manner relative to the nominal propagation axis; and
a controller coupled at least to the actuator of the second optical element and configured to induce the motion, by the actuator, of the second optical element to move the light beam, as incident on the target, relative to the nominal propagation axis.

51. The system of claim 50, wherein:
the first optical system is coupled to a respective actuator; and
the controller is configured to induce motion of the actuators independently of each other.
